(19) United States
(12) Patent Application Publication
(10) Pub. No.: US 2010/0134296 A1
(43) Pub. Date: Jun. 3, 2010

(54) Hand hygiene verification/tracking system and method

(76) Inventor: Franklin D. Hwang, Glendora, CA (US)

Correspondence Address: John F O'Rourke;Wang Hartmann Gibbs&Cauley, 1301 Dove Street, Suite 1050, Newport Beach, CA, 92660, US

(21) Appl. No.: 12/311,063

(22) PCT Filed: Oct. 31, 2007
(86) PCT No.: PCT/US2007/022954

§ 371 Date: Mar. 18, 2009

Related U.S. Application Data
(60) Provisional application No. 60/855,764, filed on Nov. 1, 2006.
(60) Provisional application No. 60/855,763, filed on Nov. 1, 2006.
(60) Provisional application No. 60/924,772, filed on May 31, 2007.
(60) Provisional application No. 60/924,773, filed on May 31, 2007.
(60) Provisional application No. 60/924,953, filed on Jun. 6, 2007.

(51) Int. Cl. G08B 23/00

(52) U.S. Cl. 340/573.1

(57) ABSTRACT

A system and method for monitoring and tracking the thoroughness of hand washing/cleansing of personnel who must undergo hand hygiene frequently during a day's work schedule including (1) dispensers for dispensing a soap/disinfectant containing a visibly detectable marker agent, (2) photometric means for quantitatively measuring the marker agent present after an individual's hand cleansing procedure and determining whether or not a preset standard of hand hygiene has been met, (3) means for recording the time/date of each hygiene event along with the identity of the involved individual, and (4) collating the data into a coherent report of the hand hygiene frequency and effectiveness undergone by each staff for each day as well as tracking the history of compliance by each individual, department, etc.

### RELATED APPLICATIONS

This application claims the benefit of U.S. Provisional Applications No. 60/855,763, 60/855,764 filed on Nov. 1, 2006; 60/924,772 and 60/924,773 filed on May 31, 2007; and 60/924,953 filed on Jun. 6, 2007. The contents of said applications are incorporated herein by reference. In addition, the contents of PCT application Ser. No. ______, entitled Verifiable Hand Cleansing Formulation and Method filed on ______ and assigned to the same assignee as this application is incorporated herein by reference.

### TECHNICAL FIELD

This application relates to a system and method for verifying and tracking the hand hygiene procedures followed by personnel involved in tasks, such as providing health care, where proper hand hygiene is of utmost importance.

### BACKGROUND ART

Hand hygiene is critical in preventing infectious microorganisms, i.e. germs, like methicillin-resistant Staphylococcus aureus (MRSA), vancomycin-resistant Enterococcus (VRE), Clostridium difficile, E. Coli, salmonella, etc., from propagating in healthcare settings such as hospitals and urgent care facilities. Hand hygiene is also very important in the restaurant and food preparation industries along with prevention of epidemics in public health.

It has been published that some 80,000 patients die annually due to infections contracted in the U.S. hospitals and many more suffer serious complications due to infections resulting in an estimated cost around $36 billion dollars to the health insurance companies and hospitals. Propagation of germs by the health workers from one patient to another is a primary cause of raging infection problems in the hospitals. All evidences and studies have established that proper hand washing procedure is a major step for greatly reducing the infections in healthcare settings. Unfortunately, even under strict monitoring, it is estimated that only 60% of the healthcare workers adhere to an appropriate hand washing procedure and frequency, under monitored conditions, while less than 44% will comply if only education/training without monitoring is instituted. With intense education and training of staffs, the compliance to frequent and proper hand washing is still low (less than 44% without close monitoring and around 60% under constant observation). One of the key issues of non-compliance is inconvenience due to the location of wash basins as well as pressing workloads. Furthermore, many of the hand washing processes performed are ineffective due to inefficient antibacterial soap, incomplete hand scrubbing and rinsing or even touching the contaminated water faucet, soap, soap dispenser, sink or hand dryer to render the hand washing effort null.

In the food industry, the statistics are even worse with many of the workers only casually rinsing their hands after using the rest rooms or handling the raw meats. Introduction of E. coli, salmonella, hepatitis, etc. by unclean hands have caused many cases of food poisoning and out breaks each year. Not only personal loss and suffering are the results, but also economic loss due to sharp decline of business and long term brand reputation damage.

The U.S. Center for Disease Control and Prevention (CDC), after extensive research studies and field trials, has highly recommended that hand scrubbing for 15-20 seconds with soap is essential to remove contaminants and allow the soap or antimicrobial agents within the soap to kill off the transient and residential germs on hands. While monitoring the frequency of hand washing, via human observers, may be relatively easy, evaluating and recording the vigorous hand scrubbing required for verification purposes, is next to impossible. Consequently, at the present, there is no effective method of ensuring the effectiveness of hand washing for hospitals or food processing facilities to utilize.

As an example, many hospitals employ nurses to observe and record the hand washing frequency and elapsed time each hand washing process of their staff. The recorded data is unreliable at best since the time one spends in front of a wash basin does not automatically translate to thorough hand scrubbing, thus effective hand washing. Also some hospitals rely on soap used as an indicator of the amount of hand washing by its staff. This approach only provides a measure of the total number of hand washing done during a period of time, but there is no gage on the effectiveness of each hand washing event.

To reduce the work routine interruption due to the requirement of frequent hand washing, CDC has recommended, after extensive studies, the usage of rinse-less disinfectant to cleanse hands in between patients, if there is no obvious contaminations on hands, to achieve the antimicrobial actions necessary. Also, regardless whether gloves will be worn to handle a patient, the guideline has been at least cleansing one's hands with rinse-less disinfectant prior to taking care of a patient. Again, the present human observation and rinse-less disinfectant usage amount monitoring doe not constitute an accurate hand hygiene monitoring and tracking system.

Two prior art patents (U.S. Pat. Nos. 5,900,067 and 6,524,390) introduce a fluorescent agent into the soap solution and examine the hands after rinsing to see whether any fluorescence is left behind to assure the hands no longer have soap left over. This approach also does not provide a measure of the effectiveness of any scrubbing action during the hand washing process. U.S. Pat. Nos. 6,038,331 and 6,970,574 utilize a pattern recognition method to determine the soap coverage on a person's hands as a measure of the effectiveness of hand washing process.

Another set of prior art patents/publications (like U.S. Pat. Nos. 6,975,231, 6,727,818, 6,392,546, 6,236,317, 5,966,753, 5,945,910, 5,793,653, 5,610,589, 5,202,666, and WO03082351) disclose a variety of hand hygiene monitoring systems. The disclosed systems record who has performed hand washing procedure by determining extent of soap and rinse water dispensed after a time period. However, none can actually monitor the hand scrubbing phase after the soap has or rinse-less disinfectant has been dispensed. Several of theses prior art references dictate that extra steps must be undertaken by persons wearing the identification tags to register their tags with the monitoring device to assure proper recording who is undergoing the hand washing or cleansing procedure. Furthermore, none of these prior art references put forward a method of correctly identifying the person undergoing the hand hygiene procedure and without this accuracy any monitoring system will be useless for its stated purpose. Furthermore, none of these prior art references stipulate a method of distinguishing the person(s) entering into or exiting from a controlled access area with respect to those already within the area. Again, this is an important parameter making a monitoring/tracking system truly useful.

There is a need for a hand hygiene system which correlates the frequency and effectiveness of the hand cleansing procedure of each individual of a group involved in a health care or food handling setting and in particular such a system which is minimally intrusive to the individual's work routine.

### SUMMARY OF THE INVENTION

A system, in accordance with the present invention, for determining and tracking the frequency and effectiveness of the hand hygiene of each of a group of individuals providing services in the health care or processing/handling food fields in which proper hygiene is determined by detecting an acceptable level of light emitted by a marker provided as a constituent of a soap/disinfectant includes the following:

1) at least one and preferably a plurality of soap/disinfectant dispensers, stationary and/or portable;

2) at least one and preferably a plurality of marker activators, i.e., light sources, for illuminating the marker present on the individual's hands after a hand cleaning/disinfectant procedure;

3) at least one and preferably a plurality of photometric detectors for measuring the light emitted by the marker present on the individual's hands following the cleaning/disinfectant procedure, each activator and detector preferably being integrated into a single monitor;

4) individual identifier means associated with each monitor, the identifier means preferably comprising a tag to be worn by each individual with each tag providing an ID code signal unique to the individual wearing the tag and a tag reader associated with and preferably integrated with the monitor for interacting with the tags either passively or actively (via RF or IR) to provide an ID code signal representative of the individual wearing the tag; and

5) data processing means which preferably is located in the monitors, but may be in a separate CPU, responsive to the level of light detected by the detector and to the ID code signal for comparing the detected light level with a preset level representative that the hands that have passed or failed the acceptable hygiene level, correlating the pass/fail indication with the ID code signal and recording the event so that the frequency and effectiveness of each individual hand cleansing/disinfectant procedure can be verified and tracked. Preferably the monitors are provided with visual and/or audio means to provide instructions with respect to the hand washing and examination procedure.

Optionally, a conventional entry/exit subsystem providing entry/exit signals may be installed in the doorways of restricted access areas like patient or operating rooms with an associated monitor reading the ID tags to determine who is a new entrant and inform him/her of the necessity to perform the hand hygiene procedure and have it checked by a monitor positioned in the access area.

In addition, stationary and portable rinse-less disinfectant dispensers may be used to allow staff personnel to cleanse their hands before or after entering a restricted access area such as a patient's room along with a monitor located in or adjacent the room to evaluate the cleanliness of a new entrant's hands. The disinfectant dispensers may be arranged to record the time/date of each dispensing event along with the identity of the use for correlation with the restricted access monitor's evaluation of any new entrant's failure to have his/her hands examined.

### BRIEF DESCRIPTION OF THE DRAWINGS

FIG. 1 is a perspective view of a manually or hand proximity activated soap/disinfectant dispenser and a washing monitoring and verification module apparatus or the monitor, suitable for use with the present invention positioned above a typical wash basin;

FIG. 2 demonstrates the hands undergoing a washing action at the site of FIG. 1;

FIG. 3 illustrates the disassociated marker present on the hands being inspected by the monitor of FIG. 1 for verifying that proper hygiene has been followed;

FIG. 4 shows the hands being rinsed in the wash basin of FIG. 1;

FIG. 5 shows the hands being presented to the monitor of FIG. 1 after the rinsing process;

FIG. 6 shows the hands being dried under the dryer of FIG. 2;

FIG. 7 is an enlarged perspective view of the monitor of FIG. 1;

FIG. 8 is an enlarged view of exemplar pictograms displayed by the monitor of FIG. 7;

FIG. 9 is a functional block diagram of a hand hygiene verification and tracking system in accordance with the invention illustrating the hardware and associated software;

FIG. 10 is a flow diagram showing the timing and event sequence of the monitoring and recording sequence of the system;

FIG. 11 is a flow chart in block format showing the logic steps followed by the system;

FIG. 12 is a functional block diagram of the components of a smart wall mounted dispenser;

FIGS. 13a, 13b, 13c, and 13d are simplified perspective views of a wash basin based dispenser and monitor, a wall mounted smart disinfectant dispenser, a portion of a restricted access area such as a patient's room with a monitor mounted therein, and a CPU and/or computer in communication with the monitors and dispensers, respectively;

FIG. 14 is a perspective view of a portable rinse-less disinfectant dispenser cartridge and a container therefor;

FIG. 15 is a perspective view of a docking station for the portable dispenser of FIG. 14;

FIG. 16 is a perspective view of a restricted area access monitor;

FIG. 17 is a view of manual dispensing rinse-less disinfectant onto hands;

FIG. 18 shows the hand rubbing with rinse-less disinfectant to kill off germs on hands;

FIG. 19 is a view of examining the hands after cleaning with rinse-less disinfectant;

FIG. 20 is a typical daily hand washing report for one individual generated by the system; and

FIG. 21 is an example of a daily maintenance report issued by the system.

### DETAILED DESCRIPTION OF THE PREFERRED EMBODIMENT

### Overview

As pointed out in the “Background of the Invention” there is a necessity for an accurate hand hygiene verification and tracking system in many industries to prevent cross infections, such as in hospitals, restaurants and many of the food processing facilities as well as in the hotels and on cruise ships. Furthermore, there is a need for such system is to be implemented with minimal intrusions to the work routines and without requiring an elaborate installation or an extensive worker training process.

The present invention meets these criteria with the following four (4) principal parts:

(1) the use of a photometric measurement, via a monitor, to readily differentiate the level of marker, mixed into the soap/rinse-less disinfectant and dispensed on the hands of an individual working in a facility requiring good hand hygiene, and make a judgment as to whether or not a proper hand washing or cleansing procedure has taken place;

(2) the use of individual identification means and preferably in the form of interactive wireless identification tags (worn by each individual) and a tag reader located in the monitor to accurately determine who is the person undergoing the hand washing or hand cleansing procedure;

(3) the use of logic and memory circuitry (embedded in a microprocessor preferably within the monitor) to record the person's identification code, event time-date and results to provide an accurate record of the said person's hand hygiene routine; and

(4) the interlinking of all the monitoring and dispensing devices, preferably via wireless means, an existing network for transferring the collected data to a centralized CPU.

Optionally and preferably monitors may be placed in restricted access areas such as a patient's room along with an entry/exit sensor in communication with the respective monitor so that new entrants can be advised to have their hands checked for cleanliness.

Also, smart stationary and portable (to be carried by all personnel anticipated to enter restricted areas) rinse-less disinfectant dispensers are provided to allow staff personnel to cleanse their hands before or after entering a restricted access area, the smart dispensers being arranged to record each dispensing event along with the identification of the individual.

Also, the data processing and reporting formats may be tailored to provide the user, such as a hand hygiene supervisor, not only the frequency and effectiveness of each person's hand hygiene for the day, but also a history, comparison between departments to enable the cross infection to those persons that performed hand hygiene poorly to be tracked.

In addition, fluid level sensors (such as a conventional IR level detector or dispensing actuator counter) may be and preferably are incorporated into the dispensers and electrical sensors, e.g., for measuring the battery charge level, may be incorporated in the battery compartment of battery powered devices to form a self-diagnostic network to optimize the system and insure continuous functionality, i.e., to insure that the dispensers always have the designated soap or rinse-less disinfectant therein and that the batteries remain in a charged condition. Other features of the invention will become apparent from the following description.

In addition to the hardware/software, the invention includes a method of promoting proper hand hygiene grading and tracking the hand hygiene of those using the system.

The sections below describe: a) examples of soap and rinse-less cleansing disinfectant solutions as modified to utilize the features of the invention, b) the hand washing cleansing monitoring process, the hand cleansing steps, c) the hand inspection within a controlled access area, and d) interlinking of all the devices to form a verification and tracking system as well as the methods to assure accuracy, reliability and ease of implementation of the system in a variety of facilities. These sections illustrate the scope of the invention in its varying embodiments.

Modification of Soap and Water-Less Disinfectant Solutions for Use in the System

Two Soap Solutions:

(1) A fluorescent agent composed of 2.5% by weight of fluorescent agent 8-anilino-1-naphthalene sulfuric acid in an aqueous solution of 10% glycol by weight is formulated, which in term is added to an over-the counter liquid soap from Dial® (White Tea & Vitamin E Pearls) to constitute 0.1% by weight of the fluorescent agent. The modified soap solution is injected into a dispensing cartridge of a liquid soap dispenser available from Gojo Industries for usage in hand washing procedure. This type of soap solution is similar to the ones described in U.S. Pat. Nos. 5,250,223, 5,900,067 and 6,524,390.

(2) A separate set of formulations based on Spectra White PD dye (supplied from Spectra Color Corporation) is prepared. 10% by weight of the water soluble dye is combined with binder formed by lactose, microcrystalline cellulose and hydroxypropylmethylcellulose. 1% by weight of the dye in aggregates is mixed into liquid foam soap supplied by Medline Industries, Inc. The much smaller particle size of a few microns allows the formulation to be dispensed through a fine filter as foam. The formulation changes Medline (supplied by Medline Industries, Inc., Mundelein, Ill.) soap's original orange-reddish color to more reddish color. See my co-pending PCT application referred to in the Relation Application Section for the other examples. This formulation is filled into a modified Gojo wall-mounted dispenser (described below) cartridge for dispensing. As is discussed in the above-mentioned co-pending PCT application, vigorous scrubbing is required to disassociate the marker from the binder to enable the marker to be detected.

Two Rinse-Less Hand Cleansing Disinfectant Solutions:

(1) 7-hydroxymethyl coumarin (7-HMC or coumarin-4) dye supplied by Spectra Color Corp. as the fluorescent agent and 2-diethylamino-ethanol as a fluorescent maintenance agent is added into a non-alcohol disinfectant solution called “Hand Clens” supplied by Woodward Laboratory to constitute a solution with 0.1% by weight of the 7-HMC dye and 1% by weight of the 2-diethylamino-ethanol. This modified solution is dispensed as foam in a modified wall-mounted Gojo dispenser (described below).

(2) Coumarin-4 as the fluorescent agent and butyl amine as a fluorescent maintenance agent is added to a disinfectant of 70% ethanol to constitute an alcohol gel of 0.2% by weight of Coumarin-4 and 1% by weight of butyl amine. This alcohol gel is also dispensed from a modified wall-mounted Gojo dispenser for non-rinsing hand cleansing procedure.

### Specific Examples Showing the Measurement of the Induced Fluorescent Intensity as Criteria for Evaluating the Effectiveness of Hand Washing/Rinsing and Hand Cleansing

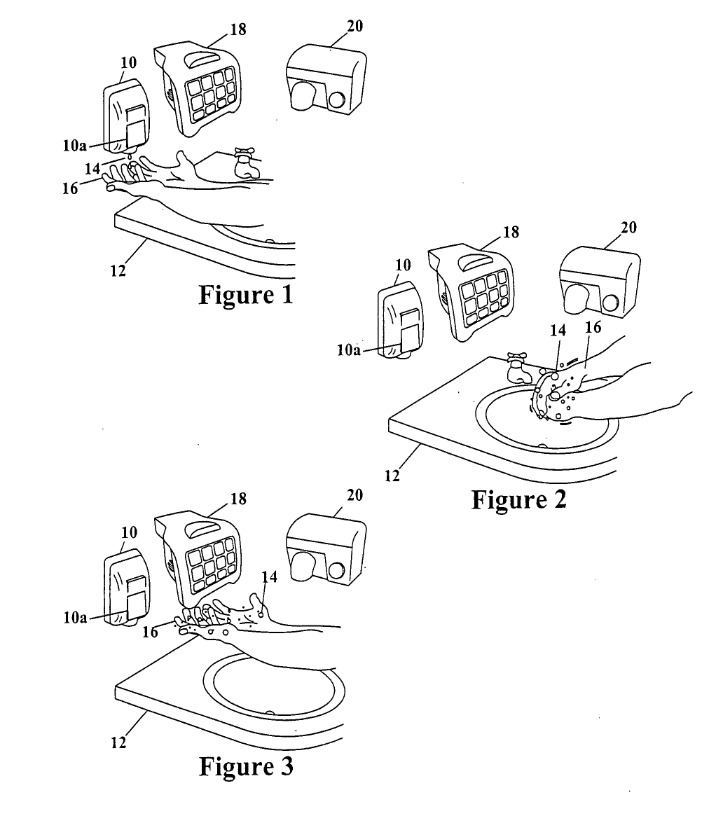

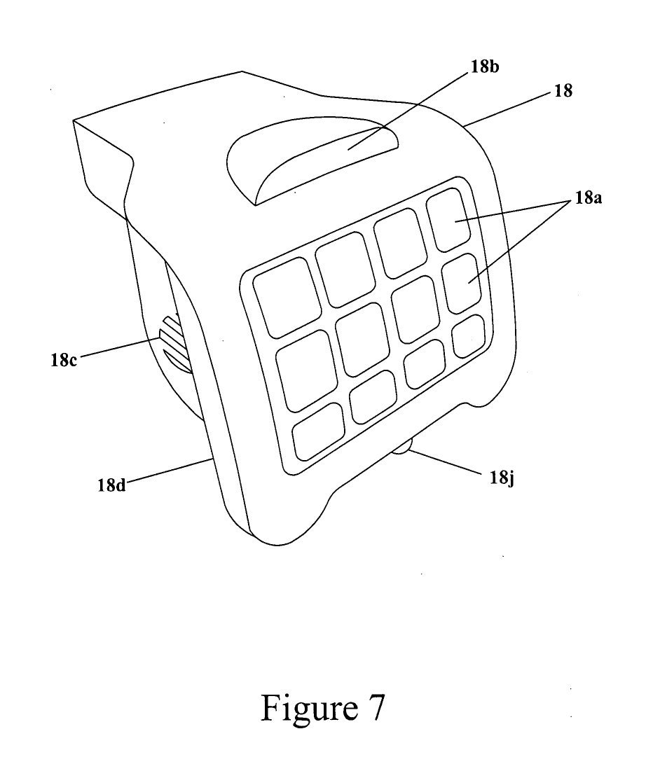

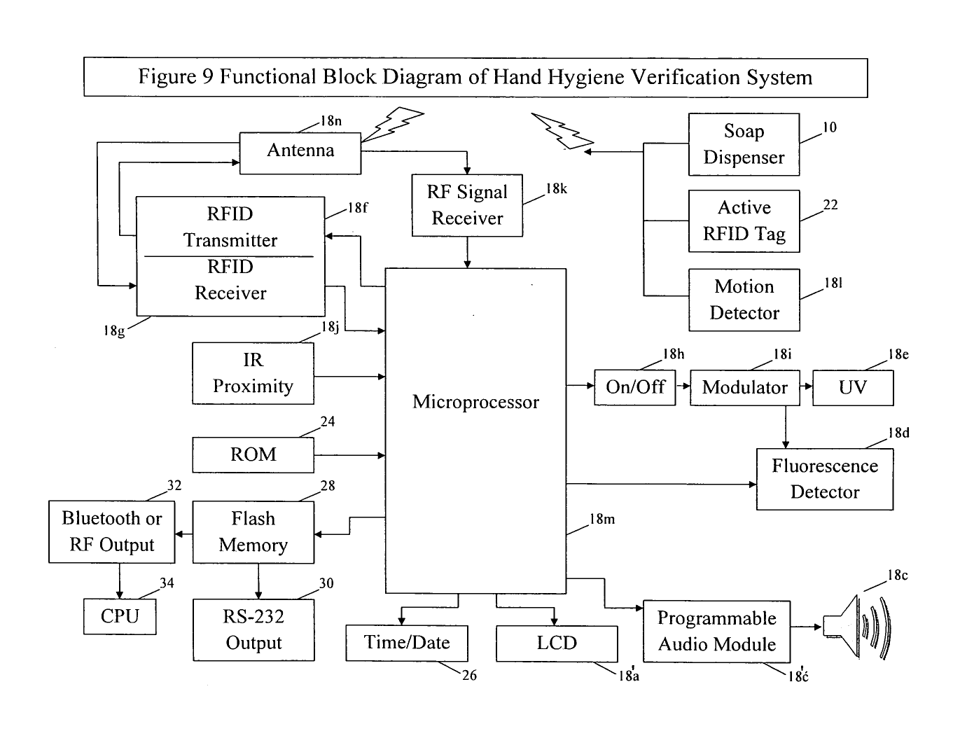

A Roscolux #388 color filter (by Rosco Laboratories, Inc.) is used to cover a 1″×2″ photovoltaic cell 18d, which is connected to a voltage signal amplifier for measuring the green-yellow wavelength region generated by the fluorescent agents used in the four solutions described above when exposed to 370 nm UV light. This detection setup is then housed in a monitor casing 18 looking downward to view the hands presented underneath. The photovoltaic cell panel is surrounded with a marker activator 18e, i.e. 6 UV LEDs (peak emission wavelength at 375 nm), and their power supply is modulated at 700 Hz identical to the detection photovoltaic cell. See modulator 18i, FIG. 9. These items are included in the monitor shown in FIGS. 1-7 and broken out in block form in FIG. 9. The monitor housing may include an infrared (IR) proximity sensor (18j, FIG. 9) to sense the presence of hands extending below the unit and turn the detection system ON to measure the fluorescence intensity level on the hands as is illustrated in FIG. 7.

Dry hands and wetted hands are initially presented to this detection setup to establish a base line. Voltage measurements will vary with respect to the color of the skin, but mostly the measurements are of less than 100 mV in this example. The darker skin typically will have lower voltage reading due to less stray light reflection from the hands toward the detection photovoltaic panel.

The hands are then wetted with a small amount of water prior to dispensing 2 ml of the soap solutions for scrubbing. After vigorously scrubbing the hands from palm to palm, between fingers, palm to back of hands for 10-15 seconds, a voltage measurement of 2-3V is achieved with darker skin actually provides higher voltage readings.

After rinsing of the hands for 10 seconds, a typical measurement of less than 100 mV is again registered.

By setting a threshold of 1V initially, the detection circuitry outlined above (with the soap example) can differentiate whether a person has performed vigorous hand scrubbing or not as dictated by the CDC guideline. A logic circuitry can then lower this threshold to say 0.8V during the examination of hands after water rinsing to determine whether sufficient rinsing had been executed.

The monitor via visual display panels 18a and 18b, respectively, and optionally via the speaker 18c (in FIG. 7), leads the user through the hand washing, rinsing and inspection procedure.

The same detection setup may be used with the two rinse-less hand cleaning disinfectant solutions in which dry hands (without disinfectant solution) are measured first to establish the base line of approximate 100 mV.

After dispensing approximately 1.5 ml of the non-rinse hand cleansing disinfection solutions and rubbing the hands for 10 seconds, the fluorescence intensity is consistently measured above 2.5V with either of the disinfection solutions for duration of 1 minute. After the first minute the intensity drops off sharply to less than 0.8V after this time period.

Consequently using the detection setup and using a threshold of 1 V, the system can determine whether a person has used the rinse-less hand cleansing disinfectant solution within the past one minute, thus informing the person either to proceed or to cleanse again prior to proceed.

The Hand Washing and Hand Cleansing Monitoring Steps

The Hand Washing Monitoring

The hand washing and inspection routine is illustrated in FIGS. 1-6, requiring six simple steps. FIG. 7 is an enlarged view of the monitor, the internal component parts of which are illustrated in FIG. 9, to be subsequently described.

Referring now to FIGS. 1-6 the soap dispenser 10 (positioned above a wash basin 12), when activated by its dispensing tab 10a, being pushed or its IR hand sensor (not shown) being activated, sends an RF dispensing code signal to the monitor 18. Each monitor has its own device identification code so that the soap dispenser will communicate with only one monitor. At the same time a given quantity of soap, containing the marker 14, is dispensed onto the user's hands. This constitutes Step 1 as is illustrated in FIG. 1.

Upon activation by the dispensing code signal, the monitor 18, via RFD transmitter 18f, (FIG. 9) will prompt all the personnel ID tags 22, within its transmission range to send their identification code signals to it. The transmitter and receiver 18f and 18g, (FIG. 9) along with the associated circuitry and software of the microprocessor function as the ID code tag reader. The monitor is programmed to select the ID code signal having the greatest strength and the selected signal will most likely be sent by the tag worn by the person standing in front of the wash basin. The monitor will request this tag and only this tag to repeatedly send its ID code and at the same time request the selected individual via visual display 18a (optionally via an audio signal through speaker 18c) to wash his/her hands (Step 2). The monitor is programmed to read this ID code throughout the hand washing steps to confirm the person undergoing the procedure is correctly identified. The monitor, via visual display 18a, may also prompt the individual to wash his/her hands.

It is to be noted that the term “individual identification means” as used in claim 1(d) is not limited to the use of a personnel tag and tag reader communicating through an RF or IR signal, but includes the use of a biometric sensor, such as a thumb scanner or ID card, carried by the individual and associated reading devices. Also the term “data processing means” as used in certain claims encompasses circuitry and software performing the recited functions located within the monitor, a centralized CPU or distributed between the two.

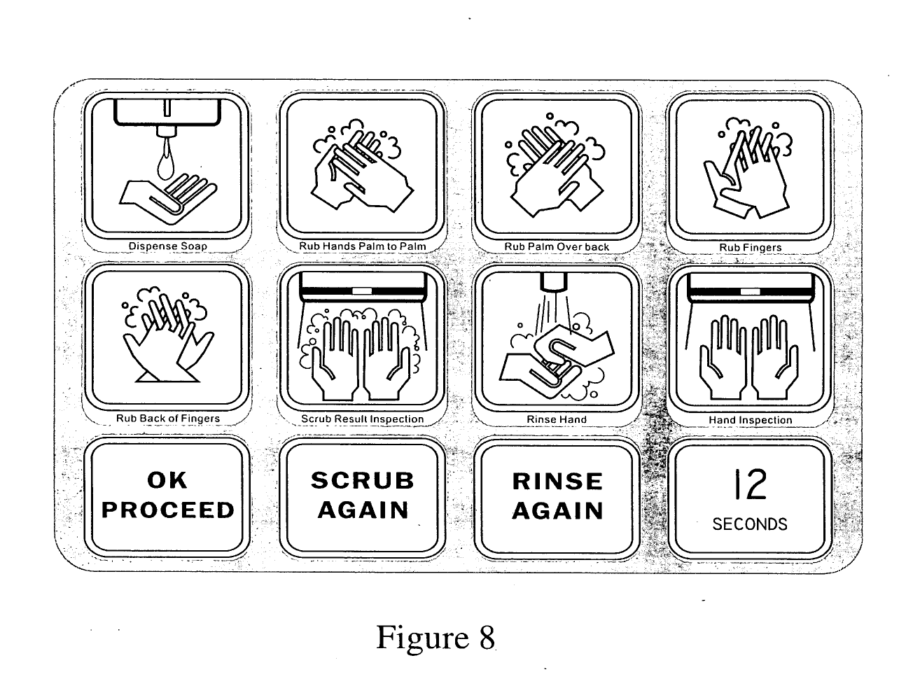

During the hand washing and inspection protocol the monitor provides a series of pictograms on the multi-faced flat-panel screens 18a outlining the steps for proper hand scrubbing along with a count-down clock for 10 or 15 seconds (software selectable), the clock output being optionally displayed on 18a. Examples of such pictograms are illustrated in FIG. 8.

Following the scrubbing interval, the monitor's display 18a will then be flashing a “Inspect Hands” message (audio prompt can also be given via a programmed audio module 18′c (FIG. 9) and speaker 18c) to prompt the person to inspect his/her lathered hands and the monitor will activate its photometric detection system 18d to measure the induced fluorescent/phosphorescent intensity on hands. This third step, i.e., hands inspection, is illustrated in FIG. 3 where the marker 14 present on the user's hands is quantitatively measured by the photometric detector 18d (FIG. 9).

If the measurement is below a pres-set threshold value (e.g. 1V or 50 mAmp), the monitor will flash the “Scrub Again” on the display 18a (or with audio prompt) to instruct the person to dispense soap and scrub his/her hand again prior to second round of hand inspection.

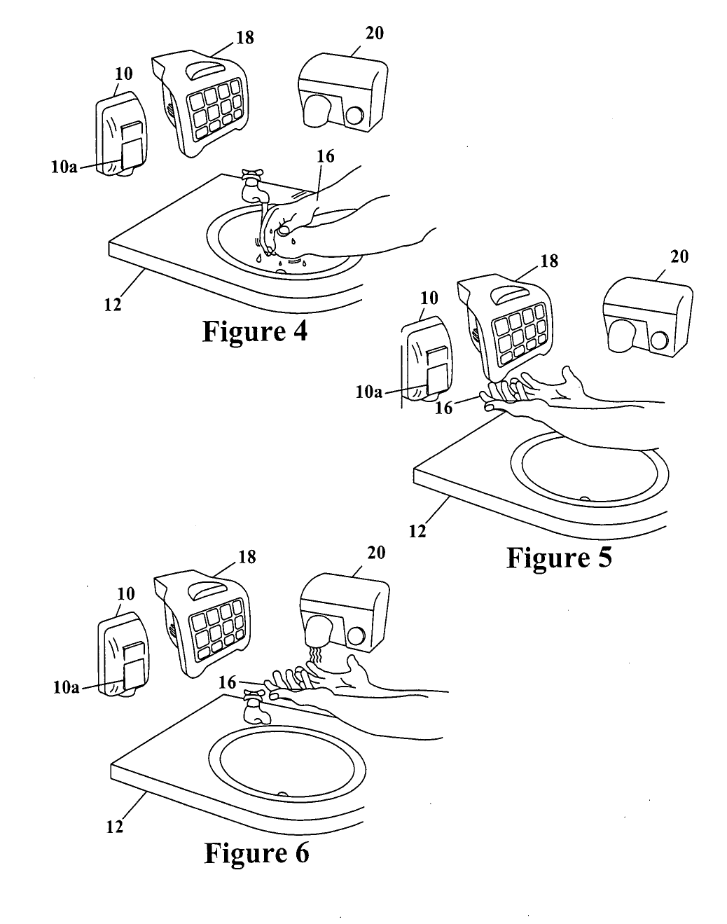

If the measurement is at or above the pre-set threshold value, then the monitor will flash “Rinse Hands” on display 18a (or in conjunction with audio prompt) for a fixed period of time (10 to 12 seconds) prior to flashing “Inspect Hands” again. The rinsing action is illustrated in FIG. 4 and constitutes Step 4 in the hand washing regime.

The rinsed hands are then presented to the detector 18d which is again activated to measure the induced fluorescent/phosphorescent intensity to make certain no appreciable amount of residual soap is left on hands, i.e. no voltage or current measurement above a reduced pre-set level say 0.8V or 20 mA (Step 5). If the measurement is above the pre-set level, then a “Rinse Again” prompt (in display 18a) will be issued prior to flash “Inspect Hands” for the second time.

When the rinse measurement is O.K. (pass), then the monitor informs the person via display 18a or by an “OK Proceed” in the pictogram panel 18a (FIG. 8) that the hand washing is done, he/she has passed. The user then dries his/her hands with, for example a conventional blow dryer 20 as is illustrated in FIG. 6 (Step 6).

The monitor will record the person's ID code, time-date of this hand washing event, pass-fail of the result, whether the scrubbing and/or rinse steps have repeated, and duration of the procedure into its memory device.

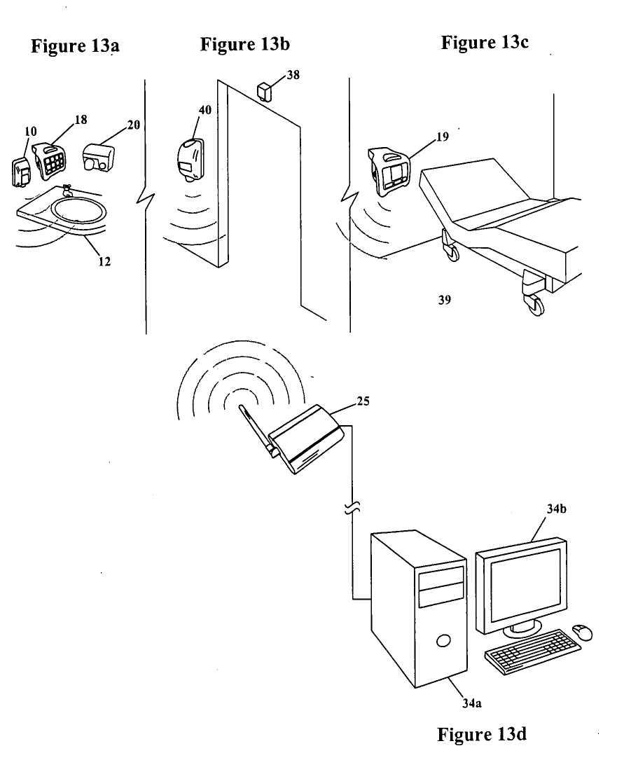

The monitor, upon prompting from an RF-Ethernet Connector device 25 in FIG. 13d via a code signal (which in turn is prompted by the CPU), will transfer its stored data and wait for the confirmation from the Connector that all the data transferred had been received and accuracy checked or a request to resend its stored data again.

The monitor will synchronize its clock with CPU 34 (shown in FIG. 13d) after the completion of data transfer, so its internal clock will always be within at most a few seconds deviation from CPU.

The Hand Cleansing Monitoring with a Rinse-Less Disinfectant

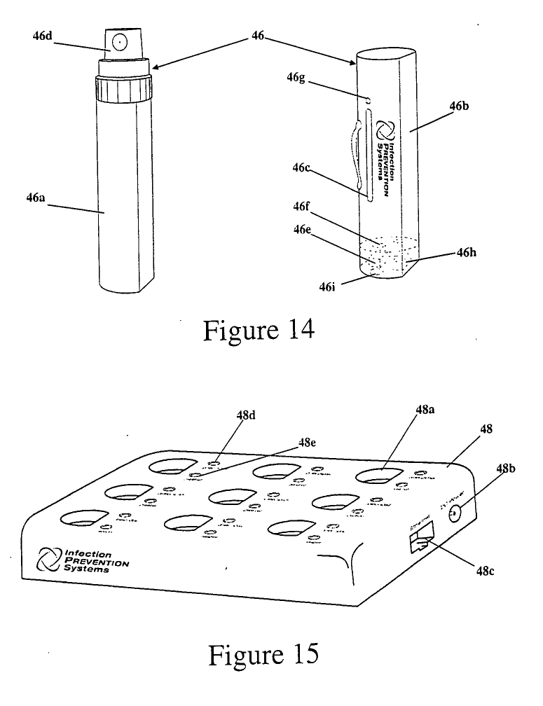

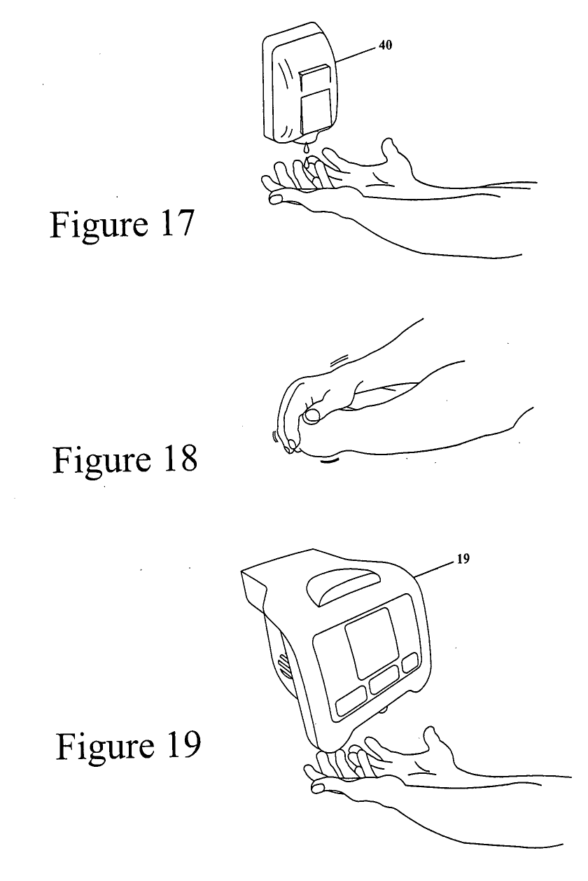

CDC as well as most hospitals have guidelines stipulating that healthcare personnel must either wash their hands or cleanse their hands with rinse-less disinfection solutions, e.g., alcohol, between the handling of different patients, regardless whether gloves are worn. Rinse-less disinfectants can be dispensed by wall-mounted dispensers such as dispensers 40 (FIG. 13b) and/or portable dispensers 46 as illustrated in FIG. 14. The same procedure as discussed with respect to FIGS. 1-3 is applicable to the use of the rinse-less disinfectant. Here a new set of figures illustrate the following steps:
Step 1 (FIG. 17) is manual dispensing of the rinse-less disinfectant solution on to the hands.
Step 2 (FIG. 18) is thorough rubbing of the hands to spread the disinfectant over all area of the hands to kill off the germs and microbial.
Step 3 (FIG. 19) is to examine the hands upon entry into a controlled access area (such as a patient room).
Step 4 is to proceed with designated tasks when “Pass” in Step 3 is obtained, otherwise another hand cleansing will be required.

The Component Parts of the Monitor and Interlinking of all Dispensers and Monitors into a Verification and Tracking System

Referring now to FIG. 9 each monitor 18 preferably has all of the elements depicted in FIG. 9, with the exception of the soap dispenser 10, the ID tag 22 worn by an individual, motion detector 18l as an entry/exit detection probe (which detects the entry and exit of an individuals into and out of a restricted control area such as a patient's room (to be described)), and a separate CPU or computer 34.

The elements of each monitor consist of: (1) the photometric detector, i.e. fluorescence detector 18d, (2) marker activator, i.e., UV LED light source 18e, (3) an on/off switch 18h and modulator 18i, (4) a IR proximity sensor 18j for detecting the presence of an individual near the monitor or optionally of an individual's hands under the detector, (5) a transmitter/receiver 18f and 18g for activating and receiving the ID code signals from the individual ID tags, (6) an antenna 18n and an RF signal receiver 18k, (7) a microprocessor 18m, programmed to perform the described functions, and (8) electronic modules 18′a and 18′c which operate the visual display 18a and speaker 18c, shown in FIG. 7.

The photometric detection system incorporated in detector 18d preferably comprises a photovoltaic cell as the detector covered by a selected optical filter (to pass just the emission wavelength region of the induced fluorescence, phosphorescence or the reflectance of the specific lighting source to the detector) along with a bank 18e of several UV, visible or IR light emitting diodes to excite the fluorescent/phosphorescent marker within the dispensed soap or disinfectant solution. Both the power to the detector and the LED(s) are preferably modulated at same frequency (e.g., 700 Hz) to increase the signal to noise ratio, thus improving the sensitivity of this photometric detection system.

315 MHz radio frequency is preferred for data transfer from the monitoring device to a centralized CPU via an interface unit called RF-Ethernet Connector 25 in FIG. 13 connecting to the Ethernet network of a facility or through a power-line network to a central CPU. This frequency is chosen due to its U.S. Federal Communication Commission's (FCC) allocation as a licensing-free band for short distance wireless control applications, such as remote car door opener, etc. Also, it is chosen for its penetrating power through walls. 2.433 GHz radio frequency is preferably used for personnel identification code transmitting/receiving between the monitoring devices/the dispensers and the persons wearing the ID tags. It may also be used for the soap dispensers to activate a monitor within a wash basin setup. The activation of a monitor located within or mounted just outside of a controlled access area such as a patient's room or an operating room provided with an entry-exit sensor may also use this frequency with an encrypted code to assure no other monitor is activated within its broadcast range.

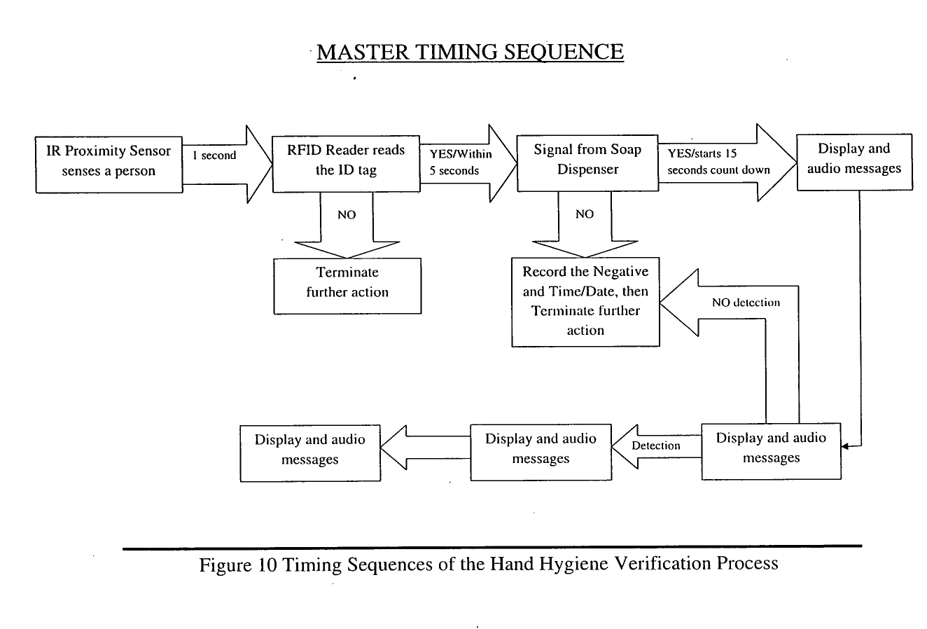

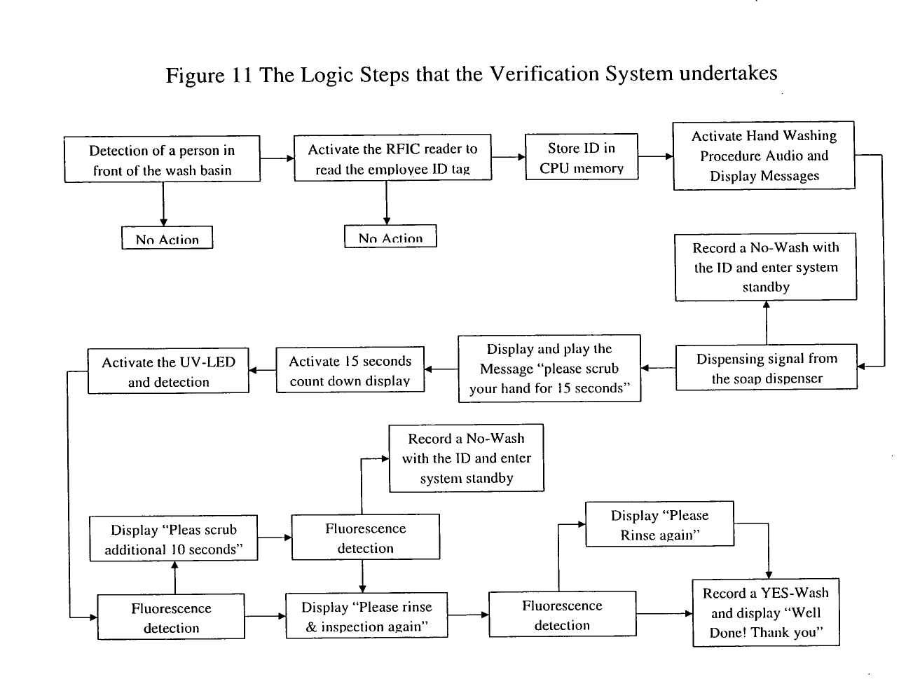

The timing and logic sequence outlined above for the system of FIG. 9 are illustrated in FIGS. 10 and 11.

Briefly, the dispenser will issue a soap dispensed signal to the monitor which in turn activates the RF ID tag reader 18k which in turn reads the individual's ID tag. The monitor also activates the displays 18a and/or the audio module 18′c to provide the messages previously discussed. After the individual's hands have been presented to the monitor, it will illuminate the hands with the appropriate light and detect the level of marker present. A pass signal (level acceptable) or a fail signal (level not acceptable) will be displayed via visual displays 18a optionally along with an appropriate message(s) via speaker 18c.

The logic sequence for the system is illustrated in FIG. 11 and is also self-explanatory.

Restricted Area Access Monitor

FIGS. 13a, 13b, and 13c illustrate, respectively, a dispenser/monitor wash basin set up, a rinse-less disinfectant dispenser 40 outside of a restricted area 39, such as a patient's room and a restricted access area monitor 19 mounted within the room 39. FIG. 13d illustrates a centralized CPU 34a and associated computer peripherals 34b in data communication with the monitor and dispenser. Each restricted area monitor has its own identification code to avoid activation by mistake from other entry/exit sensors close by and may optionally be mounted just outside the restricted area.

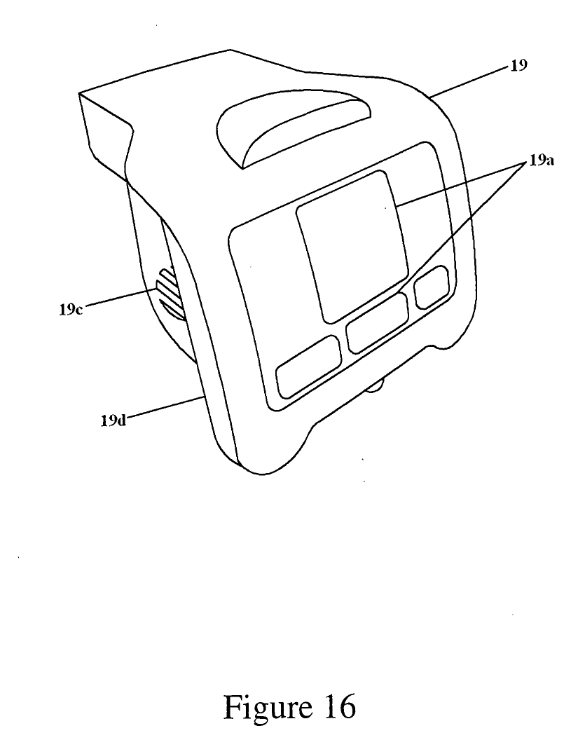

An entry/exit sensor 38 mounted on the wall adjacent to the doorway detects, via a conventional IR detector, a person entering or exiting the room and transmits coded RF entry/exit signals to the monitor representing each entry and exit. The coded entry/exit signals activate only the monitor 19 located in the associated restricted access area. See FIG. 16 for an enlarged view of the monitor 19.

If the entry-exit signal represents entry, the monitor reads the ID codes of those individuals within its range for a preset period, say 4 seconds, and enter these codes into a “New Entrants” memory buffer. Then it subtracts those codes that are stored in an “Already-in-Room” memory buffer to determine which staff personnel or visitors (without a tag) are new entrants. It will then change the “New Entrants” memory buffer into the “Already-in-Room” memory buffer. These buffers are in the microprocessor.

If the entry-exit signal is exit, it will read the ID codes of those within its range for a period of 2 seconds and entering these codes into its “New Entrants” memory buffer, then it will subtract those codes that are stored in the “Already-in-Room” memory buffer to determine which staff personnel had just left the area. Then it will change the “New Entrants” memory buffer into the “Already-in-Room” memory buffer.

If there is new staff entrant, it will activate its photometric detection sub-system 19d and visually prompt, via display 19a (FIG. 16) (or optionally audio prompt) the new entrant to have the induced fluorescent/phosphorescent intensity on his/her hands to be measured.

By determining whether the measured voltage or current is above a preset level (e.g. 1 V or 50 mA), the person is assigned a passing grade (or vice versa). This determination can also be used to produce a signal to open an access gate, if any, to the controlled area, if the restricted area monitor is mounted outside of the area.

The monitor will record the person's ID code, time-date of this event and pass-fail of the result, into its memory device.

In the event that a new entrant refuses (after being prompted) to have his/her hands examined by the monitor 19 the monitor will record a failing grade for that person. Subsequently, the system will determine (via the CPU) whether or not the individual receiving the failing grade cleansed his/her hands with a rinse-less disinfectant dispensed by a wall mounted dispenser 40 or a portable dispenser 46 (to be described) within a predetermined time prior to this failing grade, e.g., 1 minute prior receiving the failing grade. Also the CPU will examine any dispensing action (by the wall mounted or portable dispenser) which occurred within another given time say 10 seconds after the issuing of a failure grade. If the determination is in the affirmative the failure grade will be erased. In this manner, the recent (or immediately subsequent) cleansing of one's hands with the rinse-less disinfectant can eliminate the need for an inspection upon entering a restricted access area.

Upon prompting from the RF-Ethernet Connector device via coded signal (which in turn is prompted by CPU) to transfer its stored data, it will do so and awaits the confirmation from the Connector that all the data transferred had been received and accuracy checked or to resend its stored data again.

It will synchronize its clock with CPU 34 after the completion of data transfer, so its internal clock will always be within at most a few seconds deviation from CPU.

Wall-Mounted Rinse-Less Disinfectant Dispenser

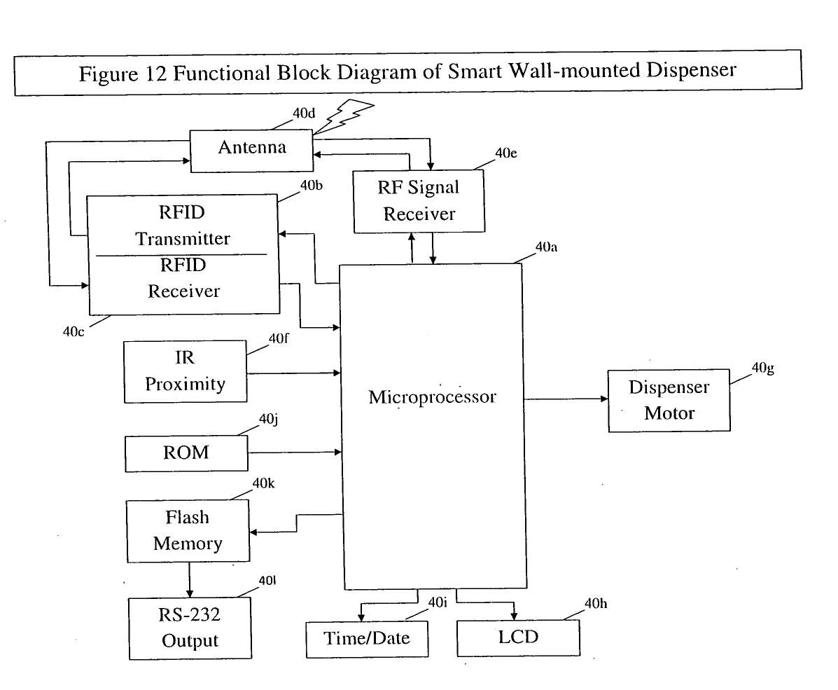

A rinse-less disinfectant dispenser 40 is illustrated in FIG. 13b as being mounted on a wall outside the controlled access area 39 (such as a patient room). This type of dispenser is considered smart in that it contains many components in common with the monitors. As is shown in FIG. 12, the rinse-less disinfectant wall monitor 40 includes a microprocessor 40a, an RFD transmitter/receiver 40b, 40c, an antenna 40d and an RF signal receiver 40e for interrogating the individuals' ID tags. An IR proximity sensor 40f senses the presence of hands under the dispenser and activates a motor 40g to dispense the disinfectant. LCD module 40h provides visual display and instruction to a user. The time and date of each event is time stamped by 40i. The microprocessor may be programmed via ROM 40j and flash memory 40k and RS 232 output 40l represent other output channels.

The dispenser 40 is activated either by the pushing of its manual dispensing tab or by its IR hand sensor 40f for touch-less dispensing as discussed previously with respect to the soap dispenser 10.

The dispenser will prompt all the personnel ID tags within its transmission range to send their identification code signals to it. By picking the strongest signal strength (most likely the person standing in front of the dispenser, it will request this tag and only this tag to repeatedly sending its ID code. The unit will read this ID code a few times to confirm the person undergoing the dispensing is correctly identified. The dispenser will then record the personnel ID code and time-date of the dispensing event into its memory.

Upon prompting from the RF-Ethernet Connector device (25 in FIG. 13d) via coded signal (which in turn is prompted by CPU 34 in FIG. 13d) to transfer its stored data, it will do so and awaits the confirmation from the Connector that all the data transferred had been received and accuracy checked or to resend its stored data again.

It will synchronize its clock with CPU after the completion of data transfer, so its internal clock will always be within, at most, a few seconds deviation from CPU.

Portable Rinse-Less Disinfectant Dispenser

A portable rinse-less disinfectant dispenser 46 as illustrated in FIG. 14 includes a disinfectant cartridge 46a, removably carried within a container 46b. A manually actuated plunger 46d allows the user to dispense an aliquot of the disinfectant onto his/her hands. The container 46b includes the necessary electronics to provide the functions described below including a disinfectant level window 46c, a battery and microchip 46e, dispenser contacts 46f, an LED 46g indicating cartridge is near empty, a USB port 46h and battery recharging contacts 46i.

The dispenser 46 is typically carried by all personnel requiring hand hygiene monitoring and tracking. It has a unique device code assigned, and it performs the following:

After the dispenser is removed by a staff personnel from a port 48a in its docking station 48 (FIG. 15) it will communicate with the ID tag of the person carrying it once and repeat this reading several times during the work shift to correlate the data collected with the person carrying it. Every time the dispensing plunger 46d is pressed an activation switch on an internal logic board records the time-date of the event as well as the personnel ID code into its memory.

During each dispensing event, it also records how many times the plunger has been pressed to calculate how much disinfectant is left in its disposable cartridge 46a, so a warning signal (visual or audio) is issued when the fluid level is getting low, preferably a visual signal via display LED 46g. When this dispenser is re-inserted into the docking station 48, it downloads its stored data to the CPU via the docking station and synchronizes its internal clock. To this end the docking station includes a DC power input 48b, an Ethernet port 48c, a downloading and charging indicator LEDs 48d and 48e for each portable dispenser plug-in port.

The docking station is arranged to receive multiple dispensers and includes, in each port, a connector 48a for receiving the data download and also for measuring the charge level of the battery in the dispenser containers. The docking port also provides charging current to the battery either before or after the downloading step depending upon the status of the dispenser's battery level.

The docking station may be programmed to read and record the personal ID code of the person removing the dispenser along with the device ID code of the portable dispenser creating a record of who is the last person used the particular portable dispenser (as a theft prevention method). The docking station in connected to the CPU via an Ethernet port 48c, and it can be powered with AC/DC adapter through connector 48b.

Central Processing Unit (CPU)

The CPU serves as the data collection, archiving, processing and reporting center for the entire system and performs the following functions through its software programs:

(1) Daily at a fixed time, it prompts all the RF-Ethernet connectors to sequentially collect data from all the monitoring, dispensing devices in charge by that connector.

(2) It also, at a fixed time on a daily basis, prompts the portable dispenser docking stations sequentially throughout a facility to transfer their stored data.

(3) It archives the raw hand hygiene data on daily basis.

(4) It examines any failure grade registered by the restricted area access monitor by locating any hand washing event or rinse-less disinfectant dispensing (by the wall-mounted or portable dispenser) undergone by the person within 1 or 2 minute prior to or within 10 seconds after the assigned failure grade. This eliminates assignment of erroneous grade to the personnel who ignore to check their hands entering into a controlled access area or gotten a failure grade upon examination and proceed to re-cleansed his/her hand when prompted by the examiner.

(5) At conclusion of each data transfer from a device, the CPU sends a time clock synchronization signal to assure all devices are in sync with the CPU on daily basis to render the data correlation meaningful.

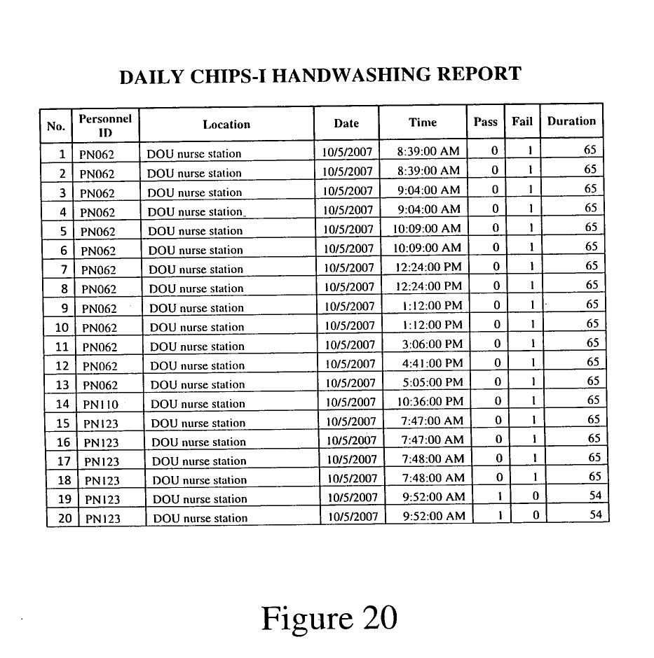

(6) It issues daily hand hygiene reports on compliance according to the formats and information required by the facility implementing this hand hygiene verification and tracking system. FIG. 20 shows one such sample report.

(7) It issues periodic hand hygiene historical reports such as on weekly, monthly, quarterly, bi-annually and annually based on sorting of the archived data.

(8) It can be linked with other data to form a more comprehensive report, such as with input of patient names and their patient room numbers that had contracted hospital acquired infections (HAI), the linkage on who were the healthcare staffs handled the patients and their hand hygiene records or with inputs of billing information with HAI cases to show the cost of non-compliance of hand hygiene by the staffs.

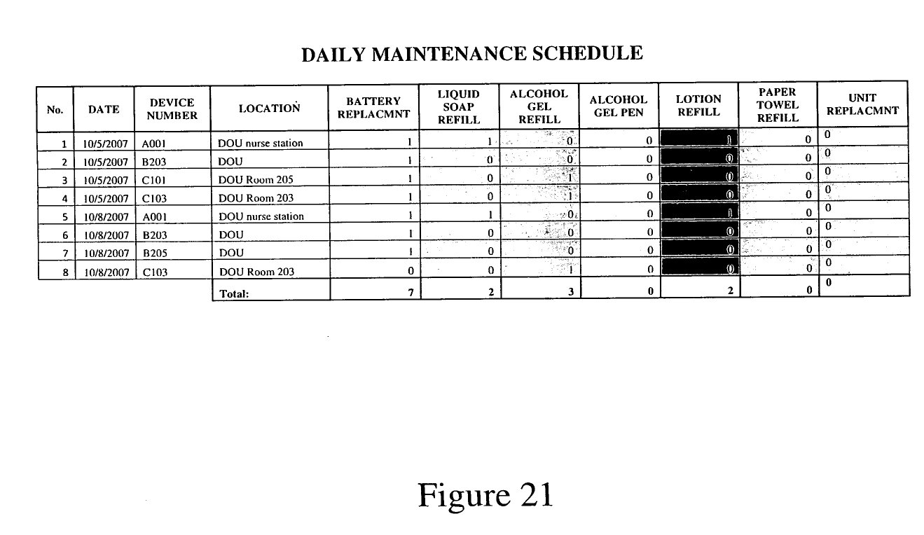

(9) It collects the battery level and soap/rinse-less disinfectant fluid level from all devices and issue a refill and battery replacement list for each device that requires maintenance for the following day. FIG. 21 illustrates such a daily maintenance log with the location of each device listed to facilitate the maintenance work.

(10) The CPU will also determine whether a device has malfunctioned based on the fact that no data can be collected from it, and thus generate a service request to replace the device.

(11) With linkage to the inventory levels of the soap and disinfectant solutions, paper towels, hand lotions, etc., the CPU automatically issue purchase alert to maintain a level of supplies to avoid any shortage.

By correctly registering every personnel on the frequency and effectiveness of his/her hand washing as well as hand cleansing throughout a work day, this hand hygiene verification and tracking system indeed can meet its goals of non-intrusive to the typical work routines and faithfully recording the number of events as well as whether each hand hygiene procedure passes its intended guideline.

What is claimed is:

1. A hand hygiene verification and tracking system for determining the frequency and effectiveness of the hand hygiene of each of a group of individuals involved, for example, in a facility providing health care or processing/handling food, in which proper hygiene is determined by detecting an acceptable level of light emitted by a marker provided as a constituent of a soap/disinfectant comprising:
a) at least one dispenser for dispensing a soap/disinfectant containing the marker onto an individual's hands, when actuated;
b) at least one marker activator for illuminating the marker present in the soap/disinfectant present on an individual's hands after a hand cleaning/disinfectant procedure;
c) at least one photometric detector for measuring the light emitted or reflected by the marker present on the individual's hands;
d) individual identifier means associated with said at least one photometric detector for identifying the individual whose hands are being examined by the detector; and
e) data processing means responsive to said at least one photometric detector and the associated individual identifier means for 1) comparing the level of the light measured by the detector with a preset level representative that the hands have passed or failed the acceptable hygiene standard; 2) correlating the pass/fail indication with the identified individual; and 3) recording the event.

2. The system of claim 1 wherein the data processing means records data representative of the date and time of each event and the identity of the involved individual to allow the hand hygiene frequency and effectiveness of each individual to be tracked and wherein the individual whose hands are being examined is informed that he/she has received a pass or fail grade.

3. The system according to claim 2 wherein said at least one marker activator, said at least one photometric detector and said tag reader are incorporated into one unit forming a monitor and wherein said at least one monitor comprises a plurality of monitors.

4. The system of claim 3 wherein the monitors are arranged to inform the individual being examined of his/her pass/fail grade.

5. The system of claim 4 further including a CPU in data communication with the monitors to record the data representative of the date and time of said event along with the identity of the involved individual to accommodate the tracking of the hand hygiene procedure events performed by each of the individuals over time.

6. The system of claim 5 wherein the monitors are arranged to provide hand washing and hand examination instructions to the individuals.

7. The system of claim 5 or 6 wherein at least one of the monitors is located in a restricted access area and further including entry/exit means for monitoring the entry/exit of individuals into the area and communicating said events to the associated restricted access monitor, the monitor being arranged to direct a new entrant to provide his/her hands for inspection by the monitor and issue a failing grade in the event that the new entrant fails to provide his/her hands for examination.

8. The system of claim 6 wherein at least some of the dispensers are arranged to disperse a rinse-less disinfectant and wherein the system is arranged to determine whether or not an individual has cleansed his/her hands with the rinse-less disinfectant within preset times before or after receiving a failing grade

9. The system of claim 8 wherein the system is arranged to erase the failing grade from the individual's record in the event that the individual has met the preset times criteria.

10. The system of claim 7 wherein the individual identifier means comprises an identification tag worn by each of the individuals for providing an ID code signal unique to each individual, and a tag reader adjacent the detector for reading the ID code of the individual whose hands are undergoing examination by the detector.

11. The system of claim 10 wherein the identification tag is active and communicates with the tag reader via an RF signal.

12. The system of claim 10 wherein the facility has a plurality of wash basins and wherein some of the dispensers and monitors are located adjacent respective wash basins with some dispensers being portable.

13. The system of claim 12 wherein the portable dispensers are arranged to dispense a rinse-less disinfectant and to communicate with the ID tags and record the ID code signal of each person carrying the dispenser along with the time and date of each dispensing event.

14. The system of claim 13 further including a portable dispenser docking station having a data processor and memory capability for downloading the event data accumulated in the portable dispenser and for forwarding the date to the CPU.

15. The system of claim 5 wherein the area in which at least one of said monitors is located in an area susceptible to accommodating more than one person and wherein the monitor is arranged to determine which individual is presenting his/her hands to the monitor by comparing the relative strengths of the received ID code signals.

16. The system of claim 15 further including an entry/exit sensor in said area in data communication with the CPU, the entry/exit sensor being arranged to provide an entry/exit signal representative that a person has entered or exited the area and is further arranged to read the ID tags of all individuals in the area, the CPU being further arranged to determine which tag bearing individuals have just entered the area, which tag bearing individuals have exited and which tag bearing individuals are still in the area.

17. A hand hygiene verification and tracking system for determining whether or not a group of individuals involved, for example, in a facility providing heath care or processing/handling food, have cleaned/disinfected their hands to an acceptable standard in which proper hygiene is determined by detecting an acceptable level of induced phosphorescent/fluorescent light emitted from a fluorescent/phosphorescent marker provided as a constituent of a soap/disinfectant solution comprising:
a) at least one dispenser for dispensing a given quantity of a soap/disinfectant solution containing the marker;
b) at least one marker activator for illuminating the marker present on an individual's hands with U.V. or IR light;
c) at least one photometric detector for providing a light level signal representative of the induced fluorescent/phosphorescent intensity emitted by the hands;
d) an interactive radio frequency tag to be worn by each individual;
e) a tag reader associated with each photometric detector for providing an individual ID code identifier signal representative of the individual;
f) data processing means responsive to the detector and tag reader for comparing the light level signal with a preset level representative of an acceptable hand hygiene standard for providing a pass or fail signal and for recording data representing the pass/fail condition along with the time, date and individual's identity.

18. The system of claim 17 wherein the marker activator and tag reader are integrated into a single monitor and wherein the single monitor comprises a plurality of monitors and wherein the data processing means is embedded in each monitor and further including a CPU in data communication with each of the monitors.

19. The system of claim 17 wherein the CPU is programmed to provide a running history of the pass/fail condition for each individual along with the time and date thereof and for generating a periodic hand cleansing report for each individual.

20. A method of verifying and tracking the effectiveness of hand hygiene of each of a group of individuals involved, for example, in the heath care or food processing/handling fields, comprising:
a) providing a plurality of soap/rinse-less disinfectant dispensers which when activated will dispense a given quantity of the disinfectant, the disinfectant including a marker visibly detectable when exposed to light in the UV, IR or visible spectrum;
b) each individual possessing individual identifying means;
c) providing a plurality of monitors possessing the capability of (1) ascertaining the presence and identity of an individual in the proximate vicinity, (2) detecting the quantity of the marker on an individual's hands when presented thereto, and (3) providing a passing or failing grade when the quantity of the marker is at or above a preset amount or below the amount, respectively;
d) directing each individual when in the proximity of a monitor to (1) activate the respective dispenser, (2) cleanse his/her hands with the same; and (3) expose the hands to the monitor for examination;
e) reading and recording the time, date, grade and the identity of each individual undergoing the cleansing/examination event; and
f) correlating the data with respect to all of the individuals to provide a history of the hand hygiene of each individual and of the group.

21. The method of claim 20 further including providing hand cleansing instructions to each individual at the time the disinfectant is dispensed.

22. The method of claim 21 further including providing an instruction to cleanse the hands again in the event that the grade is fail and again measuring the quantity of marker present after the second cleansing action, and issuing a pass/fail grade as a result thereof and recording the event.

23. The method of claim 20 wherein at least one of the monitors is located in a restricted access area and further including the steps of monitoring the entry or exit of the individuals into the room and of directing new entrants to expose his/her hands to the monitor for examination for receiving a passing or failing grade.

24. The method of claim 23 further including the steps of dispensing a rinse-less disinfectant onto an individual's hands just prior or after his/her entry into the restricted access area.

25. The method of claim 24 further including reviewing the history of any individual receiving a failing grade from restricted areas access monitor and erasing that grade in the event that the rinse-less disinfectant was dispensed on the individuals hands within a given time of the examination which resulted in the failing grade.

26. The system of claim 20 wherein some of the monitors and dispensers are battery powered and further including means for measuring the level of the soap/disinfectant in the dispenser and the battery charge in the battery operated units and wherein the system is arranged to provide periodic status reports of the levels of soap/disinfectant in the dispensers and the battery charge levels.
